(19) United States
(12) Patent Application Publication
(10) Pub. No.: US 2015/0254516 A1
(43) Pub. Date: Sep. 10, 2015

(54) Apparatus for Verified Detection of a Traffic Participant and Apparatus for a Vehicle for Verified Detection of a Traffic Participant

(71) Applicant: Conti Temic microelectronic GmbH, Nuernberg (DE)

(72) Inventors: Rolf ADOMAT, Eriskirch (DE); Patrick SCHILLINGER, Ulm (DE); Jan THOMMES, Hannover (DE)

(21) Appl. No.: 14/639,281

(22) Filed: Mar. 5, 2015

(30) Foreign Application Priority Data
Mar. 5, 2014 (DE) 10 2014 204 058.2

(51) Int. Cl. G06K 9/00; B60Q 1/14; G06T 7/00

(52) U.S. Cl. CPC G06K 9/00825; G06T 7/0042; B60Q 1/143; G06T 2207/10028; G06T 2207/30252; G06T 2207/30236; B60Q 2300/41

(57) ABSTRACT

The invention relates to the verification of a detection of other road users of a vehicle, wherein the detection is carried out based on light sources in camera images. The verification is carried out by means of a distance calculation. In particular, a stereo camera can be used, wherein a pairing of light sources in the first image and a color check of the light sources in the first image can be carried out using a first image of the stereo camera. Likewise, a distance estimate of the object, which is assigned to the light sources, can take place. Independently of this, a three-dimensional position calculation of the object which contains the light sources can be performed with a second camera image of the stereo camera. Disparities can be used for this. These two distance values, the estimated distance value and the distance value of the three-dimensional position calculation can be compared, in order to establish whether the object may actually be a preceding vehicle. It is part of the invention to provide a corresponding device which carries out the method according to the invention.

### TECHNICAL FIELD

This invention relates to light assistance systems. In particular, this invention relates to a method for the verified detection of a road user based on a detection of at least one light source in an image of the surroundings of a vehicle and a device for a vehicle for the verified detection of a road user.

### BACKGROUND OF THE INVENTION

Light functions in camera-based driver assistance systems are achieved nowadays by a mono camera as a leading sensor. For this purpose, different forms of the light assistants are used in motor vehicles. For example, known systems such as High Beam Assist, Intelligent Headline Assist or Glare Free High Beam are used in the prior art in vehicles.

In the case of the light function, one problem is the reliable differentiation of vehicles and other self-luminous objects such as, for example, reflectors, traffic lights or road signs. A reliable technology for detecting other road users, especially for preceding vehicles, is the pairing of symmetrical lights at the same height, since these are almost exclusively found on vehicles. However, the problem is that an increasing number of LED signs are provided on multi-lane roads, which often display the same road sign in pairs. Since these have a high proportion of red in their color, look the same and are located at the same height, they are usually automatically paired by the driver assistance system or the light assistant and thus lead to a false positive detection.

In particular, this means that two LED signs at some distance appear to the camera to be a preceding vehicle at a short distance.

### SUMMARY OF THE INVENTION

It can be deemed to be an object of the invention to indicate a method for improved control of the front lights in vehicles. Similarly, it can be regarded an object of the invention to provide improved detection of preceding vehicles or other preceding road users.

The object is achieved by the subject matter of the independent claims. Further developments and additional embodiments are indicated in the dependent claims, the following description and the figures.

The embodiment examples described relate equally to the method for the verified detection of a road user as well as the device and the vehicle. In other words, features which are described below with respect to the method can also be implemented in the device or the vehicle and can be regarded as corresponding features or configurations of the device. The reverse is of course also true. In particular, the device is designed to carry out the methods described below, unless otherwise explicitly indicated.

According to one embodiment example of the invention, a method for the verified detection of a road user based on a detection of at least one light source in an image of the surroundings of a vehicle is indicated. The method comprises the step of providing at least one first image of the surroundings of the vehicle. The detection of an object in the surroundings of the vehicle based on a detection of a light source of the object in the first image is a further step in this embodiment example of the method. The verification of whether the object detected is a road user, wherein said verification is effected by means of a distance calculation, is also part of this method.

The detection of an object can thereby be carried out, for example, by means of pairing lights. For this purpose, a pairing unit for detecting one or more light sources of an object in the first image can be used. As a result, the pairing unit detects the object in the surroundings of the vehicle, which object comprises the light sources. In addition, if desired, a first distance can be calculated based on the information of the first image, for example by means of an estimate. Details of embodiment examples of estimates are indicated herein. Irrespective of this, a second distance calculation can be performed, for example by means of disparities which are established in a first image and in a second image of a stereo camera. The verification is carried out in this example by comparing the first distance value and the second distance value. Further aspects of this are described below using various embodiment examples.

The verification stage by means of a distance calculation can be, for example, a three-dimensional position calculation of the lights to be verified. In this context, different images of a stereo camera of the vehicle can be used, for example, in order to check whether the object detected which contains the light sources is actually another road user, in particular a preceding vehicle. In other words, it is possible to identify another vehicle with this method. The verification can be a comparison of two distance values determined in different ways. This comparison can be used to check whether the object is a preceding vehicle. Color detection can also be carried out in certain embodiment examples. Details regarding this will be provided using various embodiment examples.

The method according to the invention therefore avoids a false positive detection, which is a disadvantage of the prior art previously described. In particular, the method according to the invention does not detect, for example, reflectors, traffic lights, road signs and, in particular, LED signs which are located at some distance and which could look like preceding vehicles at a short distance, as other road users and, in particular, it does not detect them as preceding vehicles. This makes it possible to provide an improved control of the front lighting of the vehicle, because no, or at least fewer, false detection events occur.

This method can be carried out, for example, in a light assistant of a vehicle which performs a stereo distance calculation, based on two different images of a stereo camera, by means of which the object detected or the distance of the object detected is checked and therefore verified. As will be explained in more detail below, it can be a preferred embodiment example of the invention that at least two light sources, which are contained in one image, are paired. However, it is also possible that the distance of individual red lights is verified by the method according to the invention using stereo information. Further details regarding this will be provided below.

In particular, in the context of this invention, the term “object” can be deemed to be a potential vehicle, wherein it is checked by means of the verification whether the object is actually a vehicle, or whether this is a false positive detection of, for example, a traffic light or an LED sign.

According to a further embodiment example of the invention, a pairing of light sources contained in the first image is carried out, as a result of which the object which contains the light sources is detected.

To this end, a pairing unit which is designed to pair lights, which are contained in the first image and which form part of the object detected, can, in particular, be provided in the device according to the invention. Pairs of light sources which are located at the same horizontal level can, in particular, be formed. The pairing of symmetrical lights, which are located at the same height in the images, constitutes a reliable technology, since these occur almost exclusively on cars, i.e. other preceding road users. A false positive detection can be excluded by verification of the method according to the invention based on an additional distance calculation of the object detected.

According to a further embodiment example of the invention, the distance calculation is performed as a stereo distance calculation based on a second image of the surroundings of the vehicle. To this end, the first image and the second image are generated by a stereo camera of the vehicle.

In particular, a first distance value of the object detected from the vehicle can be determined in this embodiment example, based on the first image of the stereo camera. The first distance value can be determined, for example, by the fact that based on the average width of cars and the distance between the two lights in the first image of the stereo camera, the distance of the potential vehicle is estimated. Based on the second image of the stereo camera, a second distance value of the object from the vehicle can be determined. In particular, the second calculation of the second distance value can be a stereo distance calculation. For example, a three-dimensional position calculation can be performed with the second image of the stereo camera of the vehicle by means of disparities of the lights to be verified, so that the distance is obtained in the form of the second distance value of the paired lights to the host vehicle. The two images can have been taken at the same time or at virtually the same time.

In particular, in this embodiment example, both partial images of the stereo camera are used to verify the detection of the road user. An exemplary device, which operates with a stereo camera, can be inferred from FIG. 1 which is described below.

According to a further embodiment example of the invention, the method comprises the determination of a first distance value between the vehicle and the object detected based on the first image. Determining a second distance value between the vehicle and the object detected based on a second image of the surroundings of the vehicle is also part of the method. The verification of the detection of the object is carried out as a comparison between the first and second distance values.

The two distance values can be determined by one and the same computing unit. However, it is also possible for different, structurally separate devices to carry out the first and second determination of the first and second distance values separately.

According to a further embodiment example of the invention, the second distance value is determined based on a different horizontal position of the light sources in the first and the second images.

In this context, the first image and the second image can originate, for example, from a stereo camera of the vehicle. However, it is also possible for the first image to be generated by a first camera and the second image to be generated by a second camera.

According to a further embodiment example of the invention, a three-dimensional position calculation of the object detected is performed by means of disparities of the light sources with respect to the first and second images.

The three-dimensional position thus determined can be used to answer the question of whether the previously detected object is actually another road user, for example a preceding vehicle. If, on comparing the two distances, it becomes clear that the object in question is an object further away, for example a distant LED sign, an appropriate measure can be initiated. For example, an earlier pairing of two lights can be overridden. However, other measures are also possible.

The disparity, which is also called transverse disparity in stereoscopy, denotes the spatial offset of the same object in two different images. The two images should, if at all possible, have been taken at the same time or at virtually the same time. This is part of one embodiment example of the invention. It is also part of one embodiment example of the invention that the distance from the cameras/stereo camera to the object/light source/light sources is calculated using the offset of the object/light source/light sources in the image horizontal, the horizontal distance of the two cameras from one another or the horizontal distance between two sensors of a stereo camera, and the focal length of the cameras or the focal length of the stereo camera.

This embodiment example based on the use of disparities in a first mono image and a second mono image of a stereo camera can be used with the pairing described above. In particular, the pairing can be carried out in two stages in this embodiment example, as will be explained in more detail below. In a first phase, symmetrical lights at the same height, which are located in the first image, are paired to form a pair of light sources. In a second phase, it can be checked whether the lights have a considerable red component. This can be used to check whether the object could, in principle, be a preceding vehicle. The verification according to this invention is subsequently carried out. A three-dimensional position calculation is performed with the second partial image of the mono camera by means of disparities of the lights to be verified, so that the distance between the paired lights and the host vehicle is obtained. The distance of the potential vehicle is estimated by means of the distance of the two lights from one another in the mono image, and the average width of vehicles, as a result of which a first distance value is obtained. The second distance value in this example is the value which is obtained by means of the three-dimensional position calculation by means of disparities. If the result of the estimate, i.e. the first distance value, is a nearby preceding vehicle, but the result of the calculation using disparities is a distant object, the object detected must be LED signs, for example. However, the possibility that it is a nearby preceding vehicle can be excluded. If the result of the estimate is a nearby preceding vehicle and the result of the calculation using disparities is also a nearby object, then the object is actually a vehicle. The front lighting of the vehicle can then be controlled based on this result of the comparison of the two distance values.

According to a further embodiment example of the invention, the pairing can be corrected or confirmed with the result following verification. For example, the phase of the verification described above can only be carried out for red lights which have already been paired, so that few additional resources are required.

According to a further embodiment example of the invention, the first distance value is determined as an estimate of the first distance value by means of a distance between two light sources of the object in the first image and by means of an average width of motor vehicles.

According to a further embodiment example of the invention, the vehicle's lights are controlled based on the result of the verification regarding whether the object detected is a road user.

In particular, the lights can be controlled by means of a light assistant or a driver assistance system. Exemplary embodiments of such a device will be explained in particular in the context of the description of the figures.

According to a further embodiment example of the invention, a device for a vehicle is indicated, wherein the device for the verified detection of a road user is designed based on a detection of at least one light source. The device comprises a computing unit, said computing unit being designed to verify a detection of an object in the surroundings of the vehicle, which is photographed in the first image. The detection of the object is based on a detection of a light source of the object in the first image. Furthermore, the computing unit is designed to carry out the verification by means of a distance calculation of the distance of the object detected from the vehicle.

For example, the device can be a light assistant with 3D correction. Likewise, the device can be designed to control the front lighting of the vehicle. The computing unit can be understood to be a processor, microcontroller or computer, which can be located inside the vehicle or outside the vehicle. In particular, the computing unit can be connected to other components of the device by wired or wireless means. In particular, the camera, in particular a stereo camera, can be part of the device, with which the computing unit communicates. Similarly, a pairing unit can be provided in the device, said pairing unit being designed to pair lights which are photographed in an image. In another embodiment example, a color detection unit is provided in the device. The color detection unit is designed to identify red lights in an image.

In other words, the device is designed to verify a detection of a road user, in particular a preceding vehicle, based on light signals inside the first image and a second image.

In an exemplary embodiment, the device is designed as a system which is configured to control the front lighting inside a vehicle. Included in the device is a camera which is used to detect other road users with the aid of taillights and headlights. In addition, symmetrical lights are paired within the device. These paired lights are verified via a stereo distance calculation by means of the computing unit according to the invention. In this context, this device can also be operated fully functionally without the provision of a stereo image. A stereo image is used solely for the verification. Furthermore, the distance of individual red lights can also be verified by means of stereo information.

According to a further embodiment example of the invention, a program is indicated which, if it is run on a processor, instructs the processor to carry out a method which is described in the context of this invention. The program element can be a part of a computer program. In addition, the program element itself can also be a standalone computer program. For example, the program element can be an update which makes it possible for an already existing computer program to carry out the method according to the invention.

According to a further embodiment example of the invention, a computer-readable medium is indicated, on which a program element is stored which, if it is run on a processor, instructs the processor to carry out a method which is described in the context of this invention. The computer-readable medium can be deemed to be a storage medium, for example a USB stick, CD, DVD, hard disk or other storage medium. In addition, the computer-readable medium can be designed as a microchip which makes it possible for a driver assistance system, in particular a light assistant, in a vehicle, to carry out the method according to the invention.

Further advantages, features and possible applications of the invention will become apparent from the following description of the embodiment examples and figures. All of the features described and/or illustrated, whether alone or in any combination, form the subject matter of the invention, independently of their composition in the individual claims or their references.

### BRIEF DESCRIPTION OF THE FIGURES

FIG. 1 shows a device for the verified detection of a road user based on a detection of at least one light source according to one embodiment example of the invention.

FIG. 2 shows a vehicle having a device according to one embodiment example of the invention.

FIG. 3 shows a flow chart of a method according to one embodiment example of the invention.

The figures are shown schematically and not to scale. If the same or similar reference numerals are indicated in the following description in various figures, these refer to the same or similar elements.

### DETAILED DESCRIPTION OF EMBODIMENT EXAMPLES

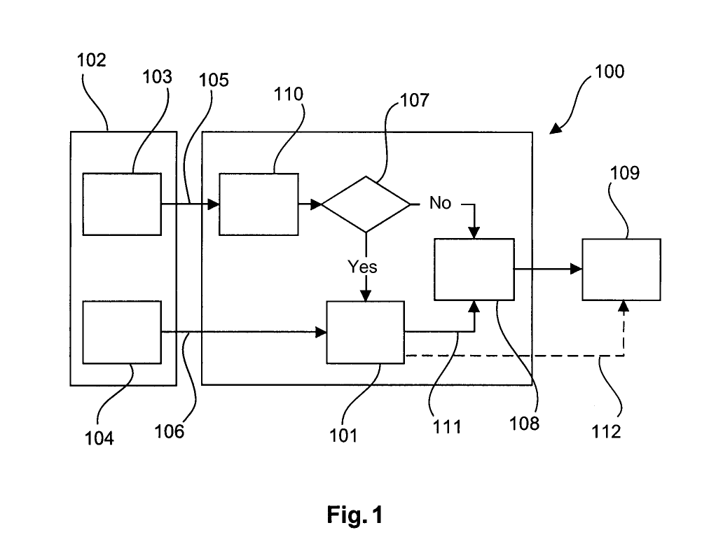

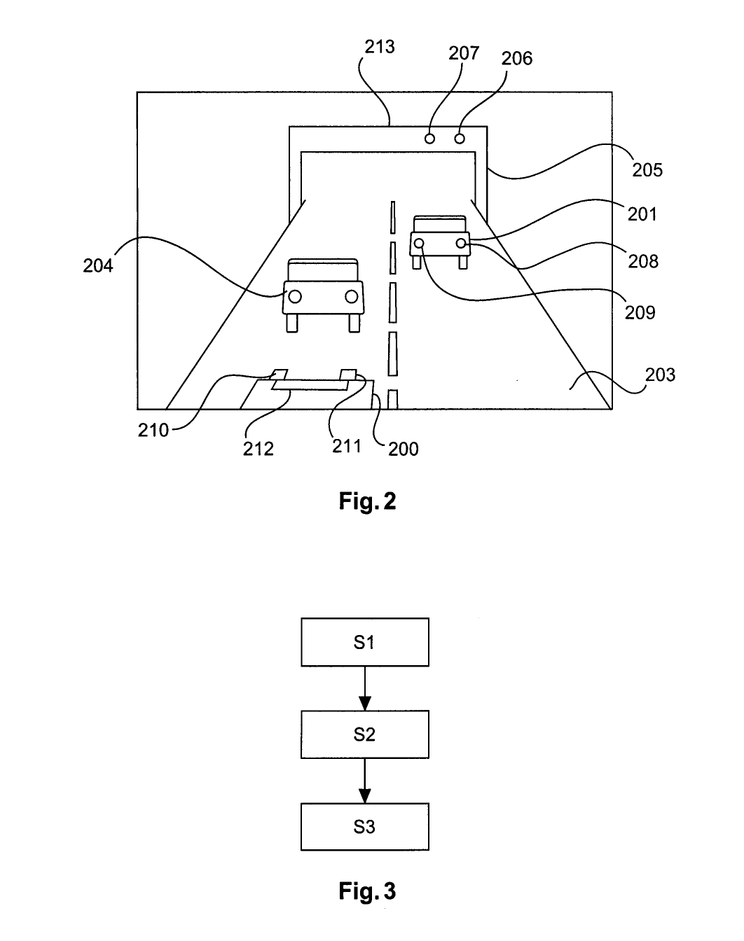

FIG. 1 shows a device 100 for a vehicle for the verified detection of a road user 201 based on a detection of light sources. The device 100 can be used, for example, in the car 200 in FIG. 2, in order to detect the light sources 208, 209. The device 100 comprises a computing unit 101, which is designed to verify a detection of an object in the surroundings of the vehicle based on a detection of the light sources of the object in the first image 105. In addition, the computing unit 101 is designed to carry out the verification by means of a distance calculation of the distance of the object detected from the vehicle. In the embodiment example shown in FIG. 1, the device 100 is designed to control a front light 109 of the vehicle (not shown here). For example, the device 100 can be deemed to be a light assistant or a driver assistance system which controls the light. In addition to the computing unit 101, the device 100 comprises a pairing unit 110. The pairing unit 110 is designed to detect one or more light sources of an object in the first image. As a result, the pairing unit 110 detects the object in the surroundings of the vehicle, which object comprises the light sources.

The first image 105 is transmitted to the pairing unit 110 by the first sensor 103 of the stereo camera 102. It can be established in the color detection unit 107 whether red lights exist in the first image 105, which can be used as a criterion by the device as to whether the object detected is a preceding vehicle. In the event that red lights in the first image 105 are detected by the color detection unit 107 and this question is therefore answered with Yes, the computing unit 101 can verify whether the object detected is a road user. The computing unit 101 verifies this by means of a distance calculation. This distance calculation is based on the second image 106, which is provided to the computing unit 101 by the second sensor 104 of the stereo camera 102. In this context, the first and second images can be transmitted by wired or wireless means. In particular, the stereo camera 102 can be part of the device 100, but it can also be arranged in the vehicle so that it is structurally separate.

In other words, the device 100 can be deemed to be a system which is used in a vehicle for controlling the front lighting. The stereo camera 102 detects other road users by means of images which are generated by the two sensors 103 and 104. A pairing is additionally carried out, with the aid of taillights and headlights, by the pairing unit 110 within the first image which is generated by the stereo camera 102. The pairing can only be carried out if, for example, two light sources are arranged at the same height in the first image. Similarly, the pairing can only take place, if the two light sources are symmetrical lights, therefore if both light sources have an identical or very similar form. The verification according to this invention is therefore only carried out in the exemplary embodiment of FIG. 1, if the paired lights have a minimum red component value due to the color detection unit 107.

For example, a value for a minimum red component can be stored in a storage unit of the device or even outside the device, said value being used as a threshold value. In the event that the paired light sources in the first image do not have any minimum red component, the component 108 can control the headlights 109 of the vehicle accordingly. In the event that the paired lights have a strong red component and could therefore be a preceding vehicle, the verification according to the invention is carried out in the computing unit 101. The pairing can be corrected or confirmed with the result of the verification as to whether the object detected is actually a road user, i.e. a preceding vehicle. This correction or confirmation is shown symbolically by the arrow 111 in FIG. 1.

According to a further embodiment example, it is, however, also possible that the first computing unit 101 directly controls the vehicle lights 109. This is illustrated symbolically by the arrow 112 in FIG. 1. The pairing unit 110 can estimate the distance of the potential vehicle based on the first mono image 105 and an average width of vehicles. This is used to determine a first distance value. Furthermore, the computing unit 101 can perform a three-dimensional position calculation based on the second partial image of the camera by means of disparities of the lights to be verified. A second distance value of the paired lights from the host vehicle is obtained. A comparison of the first and second distance values, which is carried out by the computing unit 101, constitutes the verification in this embodiment example. If the result of the value of the estimate is a small distance and the result of the calculation using disparities is a large distance, the object is not a preceding vehicle, i.e. it is not another road user. However, if the result of the estimate is a nearby preceding vehicle and the result of the calculation using disparities is also a nearby object, the object is in fact a vehicle. Based on these two different possible outcomes, the device 100 can control the vehicle lights 109.

In the process, the first computing unit 101 can determine the disparity, i.e. the spatial offset of the light sources in the two images 105 and 106. The two images 105 and 106 should, if at all possible, have been taken at the same time or at virtually the same time. The first computing unit 101 uses the offset of the light sources in the image horizontal, the horizontal distance between the two sensors of the stereo camera 102, and the focal length of the stereo camera 102 to calculate the distance from the stereo camera to the light source or light sources and, therefore, to the object, for example to the preceding vehicle or a sign.

According to a further embodiment example of the invention, FIG. 2 shows a road in the surroundings of the vehicle 200 from the viewpoint of the driver of the vehicle 200. FIG. 2 therefore only shows the front of the vehicle 200. FIG. 2 shows another vehicle 204 driving in front of the host vehicle. The vehicle 200 comprises a computing unit 210 and a stereo camera 211. These two components of a device are connected via the line 212 inside the vehicle. The LED sign 213, which has two light sources 206 and 207, is shown from the perspective of the driver of the vehicle 200. The sign 213 is firmly fixed in the ground next to the road by means of mounting columns. The road user 201, i.e. a preceding vehicle 201, has the two red taillights 208 and 209. However, both objects, on the one hand the sign 213, and, on the other hand, the road user 201, would be detected as preceding vehicles with a simple light assistance according to the prior art. In the event that the two lights 206 and 207 of the LED sign 213 have a high red component in the color and as these look the same and are located at the same height, the latter would be paired by a system from the prior art, and would therefore be identified as a false positive vehicle detection.

However, such a false positive detection of objects like the LED sign 213 is avoided by means of the method and the device according to this invention. Due to the verification according to the invention as to whether the object detected is a road user, wherein the verification is carried out by means of a distance calculation, such an error can be avoided. In particular, a second distance calculation based on a three-dimensional position calculation of the object detected can be used. It can therefore be established that the object detected is not a preceding vehicle. In particular, a comparison of two distance values can be carried out, for example by means of a first estimated distance value and by means of a distance value from a three-dimensional position calculation. It can therefore be ascertained whether the paired lights and the object which is assigned to these paired lights may actually be a vehicle.

According to a further embodiment example of the invention, a method for the verified detection of a road user based on a detection of at least one light source in an image of the surroundings of a vehicle is shown in FIG. 3. The method shown in FIG. 3 includes the provision of at least one image of the surroundings of the vehicle, which takes place in step S1. In step S2, an object in the surroundings of the vehicle is detected based on a detection of a light source of the object in the first image. The verification as to whether the object detected is a road user, said verification being effected by means of a distance calculation, is carried out in step S3.

According to a further embodiment example of the method shown in FIG. 3, a further step S4 consists of carrying out a pairing of light sources contained in the first image, as a result of which the object which contains the light sources, is detected. Similarly, the two embodiment examples indicated above can be supplemented and extended by means of further method steps which have been described in the context of this invention. In particular, a driver assistance system, a light assistant or a device for controlling the front lighting of a vehicle can carry out these methods.

In addition, it should be noted that “comprising” does not exclude any other elements or steps and “one” does not exclude a plurality. It should also be noted that features or steps which have been described with reference to one of the above embodiment examples can also be used in combination with other features or steps of other embodiment examples described above. Reference numerals in the claims are not to be deemed to limit the invention.

1. A method for the verified detection of a road user based on a detection of at least one light source in an image of the surroundings of a vehicle, with the method further comprising
providing at least one first image of the surroundings of the vehicle (S1),
detecting an object in the surroundings of the vehicle based on a detection of a light source of the object in the first image (S2), and
verifying whether the object detected is a road user, wherein the verifying is carried out by performing a distance calculation (S3).

2. The method according to claim 1, further comprising
carrying out a pairing of light sources contained in the first image, as a result of which the object which contains the light sources, is detected (S4).

3. The method according to claim 1,
wherein the distance calculation comprises a stereo distance calculation based on a second image of the surroundings of the vehicle, and
wherein the first image and the second image are generated by a stereo camera of the vehicle.

4. The method according to claim 1, further comprising
determining a first distance value from the vehicle to the object detected based on the first image,
determining a second distance value from the vehicle to the object detected based on a second image of the surroundings of the vehicle, and
wherein the verifying comprises performing a comparison between the first distance value and the second distance value.

5. The method according to claim 4,
wherein the determining of the second distance value is performed based on a different horizontal position of light sources in the first image and the second image respectively.

6. The method according to claim 3,
wherein a three-dimensional position calculation of the object detected is carried out by determining disparities between the light sources respectively in the first image and the second image.

7. The method according to claim 4,
wherein the determining of the first distance value is carried out as an estimate of the first distance value based on a distance between two light sources of the object in the first image and based on an average width of motor vehicles.

8. The method according to claim 1, further comprising
controlling vehicle lights of the vehicle based on a result of the verifying whether the object detected is a road user.

9. A device (100) for a vehicle (200) for the verified detection of a road user (201) based on a detection of at least one light source, with the device comprising
a computing unit (101),
wherein the computing unit is configured to verify detection of an object in surroundings of the vehicle based on a detection of a light source of the object in a first image of the surroundings of the vehicle, and
wherein the computing unit is configured to carry out the verification by a distance calculation of a distance of the object detected from the vehicle.

10. The device according to claim 9,
wherein the device is configured to control front lighting of the vehicle (200),
with the device further comprising
a stereo camera (102),
wherein the stereo camera includes a first sensor (103) configured and arranged to generate the first image (105) of the surroundings of the vehicle (200),
wherein the stereo camera includes a second sensor (104) configured and arranged to generate a second image (106) of the surroundings of the vehicle (200), and
wherein the computing unit is configured to perform a three-dimensional position calculation of the object detected by determining disparities between the light sources respectively in the first image and the second image.
